(19) United States
(12) Patent Application Publication
(10) Pub. No.: US 2011/0148929 A1
(43) Pub. Date: Jun. 23, 2011

(54) METHOD AND ELECTRONIC DEVICE FOR DISPLAY CONTROL THEREOF

(75) Inventor: JUN LI, Shenzhen City (CN)

(73) Assignees: SHENZHEN FUTAIHONG PRECISION INDUSTRY CO., LTD., ShenZhen City (CN); CHI MEI COMMUNICATION SYSTEMS, INC., Tu-Cheng City (TW)

(21) Appl. No.: 12/835,753

(22) Filed: Jul. 14, 2010

(30) Foreign Application Priority Data
Dec. 18, 2009 (CN) 200910311794.2

(51) Int. Cl. G09G 5/38; G06F 3/041; G06F 3/033

(52) U.S. Cl. 345/650; 345/173; 715/863

(57) ABSTRACT

An electronic device comprises a slide detector on a rim of the electronic device to detect a slide gesture. The electronic device determines a rotation command for the slide gesture. If the gesture is clockwise, the corresponding rotation is clockwise and vice versa. Each rotation is 90 degrees to interchange the electronic device between a landscape view and a portrait view.

### BACKGROUND

1. Technical Field

Embodiments of the present disclosure relate to display, and more particularly to electronic devices and a method for controlling the display orientation thereof.

2. Description of Related Art

As portable electronic devices become more compact, and the number of functions performed by a given device increase, it has become a significant challenge to design a user interface that allows users to easily interact with a multifunction device. This challenge is particularly significant for handheld portable devices, which have much smaller displays than desktop or laptop computers. Conventional user interfaces often result in complicated key sequences and menu hierarchies that must be memorized. Many of these computing devices are designed to support switching of the electronic display between two orientation modes rotated ninety degrees from each other, in portrait and landscape modes.

The display orientation of these dual-mode display systems is switched via a soft key or via a series of menu commands, or simply by an accelerometer. However, s the accelerometer solution may accidentally switch display orientation automatically at undesirable moments when minor position changes take place.

### BRIEF DESCRIPTION OF THE DRAWINGS

FIG. 1 is a block diagram of one embodiment of an electronic device for display control thereof.

FIG. 2 is a schematic view of a sample display illustrating display modes.

FIG. 3 is a flowchart illustrating one embodiment of a method for display control of the electronic device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used herein, refers to logic embodied in hardware or firmware, or to a collection of software instructions, written in a programming language, such as, for example, Java, C, or assembly. One or more software instructions in the unit may be integrated in firmware, such as an EPROM. It will be appreciated that module may comprise connected logic units, such as gates and flip-flops, and may comprise programmable units, such as programmable gate arrays or processors. The unit described herein may be implemented as software and/or hardware unit and may be stored in any type of computer-readable medium or other computer storage electronic device.

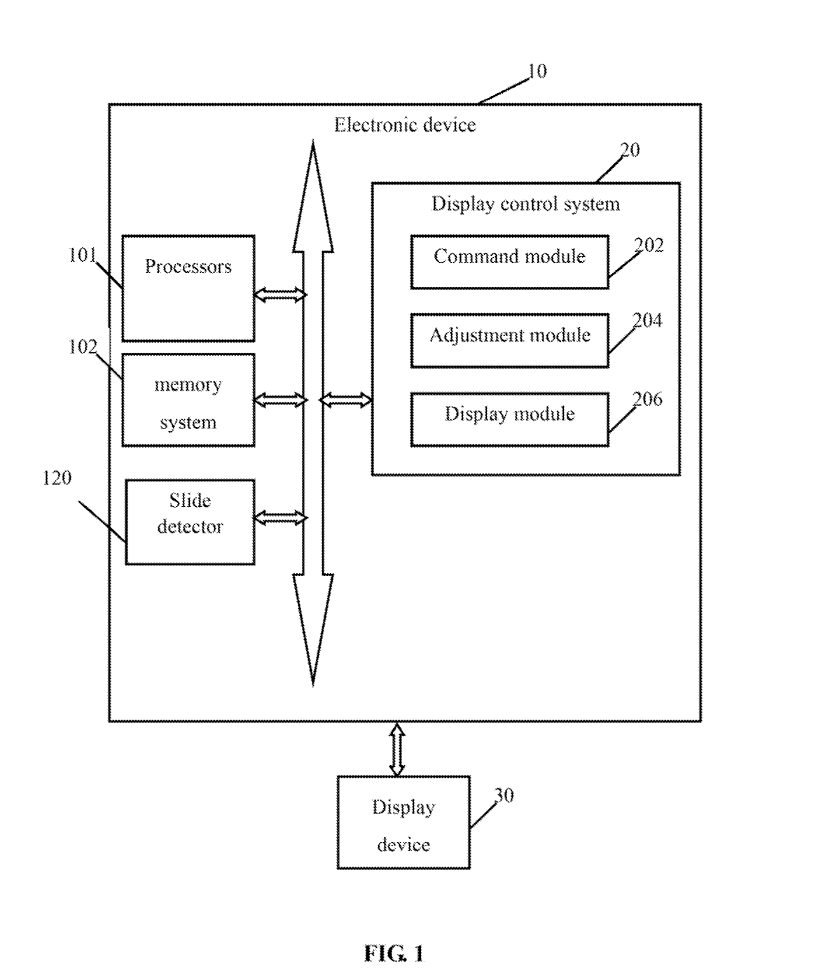

FIG. 1 is a block diagram of one embodiment of an electronic device 10 for display control thereof. The electronic device 10 includes a slide detector 120 and a display control system 20. The system 20 changes display orientation of the display device 100 of the electronic device 10 when the slide detector 120 detects a slide gesture contacting the slide detector 120. In the embodiment, the slide detector 120 can be installed on an upper-right edge of the electronic device 10, for example. In one embodiment, the slide detector 120 includes touch sensors to detect contacts and gestures on the upper-right edge of the electronic device 10. The slide detector 120 further incorporates thermal sensors to determine whether the contacts are made by fingers or other objects contacting the upper-right edge of the electronic device 10. Depending on the embodiment, the electronic device 10 can be a mobile phone, or a camera, for example. It is understood that aspects of the disclosure may practiced with a large variety of computing devices, including personal computers, handheld computers, mobile terminals, PDAs, or other devices being equally applicable.

The display control system 20 comprises a command module 202, an adjustment module 204 and a display module 206 to control a display device 30. One or more computerized codes of the modules are stored in the memory system 102 and executed by one or more processors 101 of the electronic device 10. The command module 202 determines a command for a slide gesture detected by the slide detector 120. In the embodiment, if the slide gesture is detected as being a gesture made in a clockwise direction, the command is a clockwise rotation command, and vice versa. The command module 202 sends the command to the adjustment module 204.

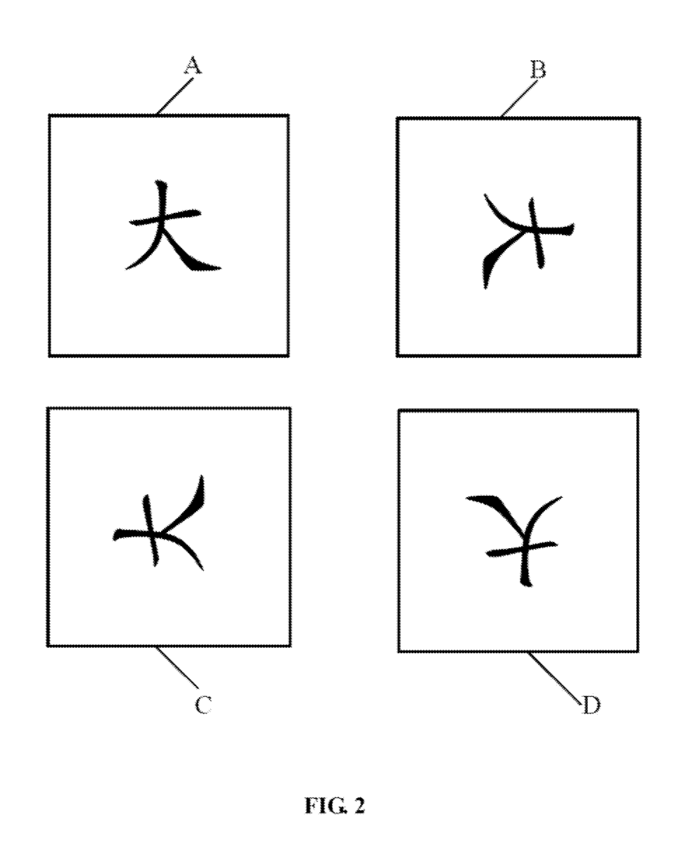

The adjustment module 204 is operable to switch between four display modes of the display module 206. FIG. 2 illustrates the four display modes of the display module 206, where mode A and C are in portrait view orientation, while mode B and D are in landscape view orientation. In the embodiment, if the adjustment module 204 receives a counter-clockwise rotation command, the adjustment module 204 switches the display mode from mode A to mode C, for example.

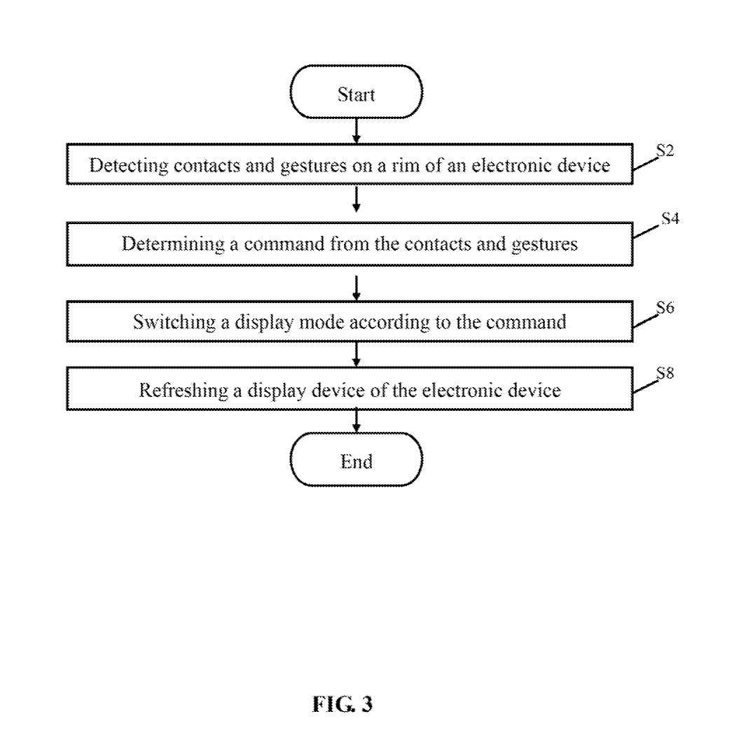

FIG. 3 is a flowchart illustrating one embodiment of a method for display control of the electronic device. Additional blocks may be added to the method, others removed, and the ordering of the blocks may be changed. In block S2, the slide detector 120 detects the contacts and gestures on the rim of the electronic device. In block S4, the command module 202 determines the command from the contacts and gestures detected by the slide detector 120. In the embodiment, if the slide gesture is detected as being a gesture made in a clockwise direction, the command is a clockwise rotation command, and vice versa. The command module 202 sends the command to the adjustment module 204. In block S6, adjustment module 204 switches the display modes of the display module 206 from a first display mode to a second display mode according to the command. For example, in FIG. 2, if the adjustment module 204 receives a counter-clockwise rotation command, the adjustment module 204 switches the display mode from the mode A to the mode C. In this case, this first display mode is the mode A and the second display mode is the mode C. In block S8, the display module 206 refreshes the display device 30 with the second display mode.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device for display control thereof, comprising:
a slide detector;
a memory system;
one or more processors;
one or more programs stored in the memory system and configured to be executed by the one or processors, the one or more programs comprising:
a command module to determines a command for a slide gesture detected by the slide detector;
a display module to control a display device of the electronic device; and
an adjustment module to switch between a plurality of display modes of the display module.

2. The electronic device as claim in claim 1, wherein the slide detector comprises touch sensors.

3. The electronic device as claim in claim 1, wherein the slide detector comprises thermal sensors.

4. The electronic device as claim in claim 1, wherein the command module determines a clockwise rotation command if the slide gesture is detected as being a gesture made in a clockwise direction.

5. The electronic device as claim in claim 1, wherein the command module determines a counter-clockwise rotation command if the slide gesture is detected as being a gesture made in a counter-clockwise direction.

6. The electronic device as claim in claim 1, wherein plurality of display modes of the display module comprise 2 portrait orientation views and 2 landscape orientation views.

7. A computer-implemented method for display control of an electronic device, the method comprising:
detecting a slide gesture using a slide detector of the electronic device;
determining a command for the slide gesture, wherein the command is stored in a memory system and configured to be executed by one or more processors of the electronic device;
switching from a first display mode to a second display mode according to the command; and
refreshing a display device of the electronic device with the second display mode.

8. The computer-implemented method as claim in claim 7, wherein the slide detector comprises touch sensors.

9. The computer-implemented method as claim in claim 7, wherein the slide detector comprises thermal sensors.

10. The computer-implemented method as claim in claim 7, wherein the step of determining a command determines a clockwise rotation command if the slide gesture is detected as being a gesture made in a clockwise direction.

11. The computer-implemented method as claim in claim 7, wherein the step of determining a command determines a counter-clockwise rotation command if the slide gesture is detected as being a gesture made in a counter-clockwise direction.

12. The computer-implemented method as claim in claim 7, wherein the first display mode is in portrait orientation and the second display mode is in landscape orientation, or vice versa.

13. A computer readable storage medium having stored therein instructions, that when executed by one or more processors of an electronic device, cause the device to:
detect a slide gesture using a slide detector;
determine a command for the slide gesture, wherein the command is stored in a memory system and configured to be executed by one or more processors of the electronic device;
switch from a first display mode to a second display mode according to the command; and
refresh a display device of the electronic device with the second display mode.

14. The computer readable storage medium as claim in claim 13, wherein the slide detector comprises touch sensors.

15. The computer readable storage medium as claim in claim 13, wherein the slide detector comprises thermal sensors.

16. The computer readable storage medium as claim in claim 13, wherein the step of determining a command determines a clockwise rotation command if the slide gesture is detected as being a gesture made in a clockwise direction.

17. The computer readable storage medium as claim in claim 13, wherein the step of determining a command determines a counter-clockwise rotation command if the slide gesture is detected as being a gesture made in a counter-clockwise direction.

18. The computer readable storage medium as claim in claim 13, wherein the first display mode is in portrait orientation and the second display mode is in landscape orientation, or vice versa.
